(19) United States
(12) Patent Application Publication
(10) Pub. No.: US 2020/0046169 A1
(43) Pub. Date: Feb. 13, 2020

(54) ROBOT SYSTEM AND CONTROL METHOD OF THE SAME

(71) Applicant: LG ELECTRONICS INC., Seoul (KR)

(72) Inventors: Jeongwoo JU, Seoul (KR); Changeui SHIN, Seoul (KR)

(73) Assignee: LG ELECTRONICS INC., Seoul (KR)

(21) Appl. No.: 16/598,889

(22) Filed: Oct. 10, 2019

(30) Foreign Application Priority Data
Sep. 10, 2019 (KR) 10-2019-0112336

(51) Int. Cl. A47J 37/12; B25J 9/16; B25J 11/00; A47J 36/32; A23L 5/10

(52) U.S. Cl. CPC A47J 37/1266; B25J 9/1664; B25J 11/0045; A23V 2002/00; A47J 36/32; A23L 5/11; A47J 37/1219

(57) ABSTRACT

A robot system includes a robot arm configured to tilt a fry basket in a first direction or in a second direction different from the first direction or lift up or lower the fry basket and a controller configured to perform a residue removal mode in which the robot arm rotates and moves the fry basket to a set residue removal path in which residue in a fryer is sifted out.

### CROSS-REFERENCE TO RELATED APPLICATIONS

This application claims the benefit of priority to Korean Patent Application No. 10-2019-0112336, filed in the Korean Intellectual Property Office on Sep. 10, 2019, the entire contents of which are incorporated herein by reference.

### FIELD OF THE DISCLOSURE

The present disclosure relates to a robot system and a control method of the same.

Robots are machines that automatically process given tasks or operate with their own capabilities. The application fields of robots are generally classified into industrial robots, medical robots, aerospace robots, and underwater robots. Recently, communication robots that can communicate with humans by voices or gestures have been increasing.

Recently, a cooking robot capable of cooking by using a robot is gradually increased and an example of such a robot is a cooking assistant robot disclosed in Japanese Patent Publication No. 4531832 (published on Aug. 25, 2010).

The cooking assistant robot is a robot that assists cooking using a cooking container disposed on a cooking burner, and includes a hand part, an arm part for changing the position and posture of the hand part, and a support part for supporting the arm part as well as at least six movable parts capable of arbitrarily changing the position and posture of the hand part.

### SUMMARY

An object of the present disclosure is to provide a robot system capable of safely and reliably handling residue in a fryer, and a method of controlling the same.

An object of the present disclosure is to provide a robot system capable of more rapidly sifting out residue from a fryer, and a method of controlling the same.

According to an embodiment, a robot system includes a robot arm configured to tilt a fry basket in a first direction or in a second direction different from the first direction or lift up or lower the fry basket and a controller configured to control the fry basket. The controller may perform a residue removal mode in which the robot arm rotates and moves the fry basket to a set residue removal path in which residue in a fryer is sifted out.

The first direction may be a direction in which the fry basket is tilted upward or downward.

The second direction may be a direction in which the fry basket is tilted forward or backward with respect to a center axis of the fry basket or is inverted by 180°.

The robot system may further include a vision camera configured to sense an image of the fryer.

The controller may analyze the image sensed by the vision camera, start the residue removal mode and end the residue removal mode.

A plurality of QR codes may be disposed on an upper portion of the fryer to be spaced apart from each other.

The plurality of QR codes may be sequentially disposed along an inner circumference of the fryer.

The residue removal mode may include a plurality of modes performed sequentially.

The plurality of modes may include a transverse traveling mode, a longitudinal traveling mode and a shaking mode.

In the transverse traveling mode, the robot arms may perform operation of lowering the fry basket into the fryer, moving the fry basket in a transverse direction and then raising the fry basket at least once;

In the longitudinal traveling mode, the robot arm may perform operation of lowering the fry basket into the fryer, moving the fry basket in a longitudinal direction and then raising the fry basket at least once; and

In the shaking mode, the robot arm may move the fry basket to the periphery of the fryer and then shake the fry basket.

The plurality of modes further may include a zigzag traveling mode in which the robot arm lowers the fry basket to a bottom of the fryer and then moves the fry basket to a zigzag path.

The controller may perform the plurality of modes in order of the transverse traveling mode, the longitudinal traveling mode, the shaking mode and the zigzag traveling mode.

The robot arm may include an end effector. Inn each of the transverse traveling mode and the longitudinal traveling mode, the end effector may sequentially move the fry basket along a plurality of parallel traveling paths.

A departure position and an arrival position of each of the plurality of traveling paths may be closer to an inner wall of the fryer than a center of the fryer.

Departure positions of the plurality of traveling paths may be spaced apart from each other in a direction perpendicular to a longitudinal direction of each of the plurality of traveling paths.

The end effector may move the fry basket on the traveling paths in a state in which the fry basket is tilted by a set angle with respect to a reference angle.

In the shaking mode, the robot arm may invert the fry basket by 180° in the second direction such that the fry basket faces downward.

In the shaking mode, the robot arm may sequentially perform a withdrawal process in which the robot arm moves the fry basket to an area outside the fryer, an inversion process in which the robot arm inverts the fry basket in the second direction, and a shaking process in which the robot arm rotates the fry basket forward and backward a plurality of times in the first direction.

In the shaking mode, the robot arm may perform a returning process of lowering the fry basket into the fryer after the shaking process.

A method of controlling a robot system including a robot arm configured to tilt a fry basket in a first direction or in a second direction different from the first direction or lift up or lower the fry basket may control the robot system. The method includes a transverse traveling step in which an end effector of the robot arms performs operation of lowering the fry basket into a fryer, moving the fry basket in a transverse direction and then raising the fry basket at least once, a longitudinal traveling step in which the end effector performs operation of lowering the fry basket into the fryer, moving the fry basket in a longitudinal direction and then raising the fry basket at least once, and a shaking step in which the end effector moves the fry basket to the periphery of the fryer and then shakes the fry basket.

In each of the transverse traveling step and the longitudinal traveling step, the end effector may sequentially move the fry basket along a plurality of parallel traveling paths.

Each of the transverse traveling step and the longitudinal traveling step may include a lowering process in which the end effector lowers the fry basket from an upper side of a departure position of a traveling path to the departure position, a traveling process in which the end effector moves the fry basket along the traveling path, a raising process in which the end effector raises the fry basket to an arrival position of the traveling path, and a movement process in which the end effector moves the fry basket to an upper side of a departure position of another traveling path adjacent to the traveling path along which the fry baskets moves in the traveling process.

In the movement process, the end effector may move the fry basket in an oblique direction crossing each of the traveling path of the transverse traveling step and the traveling path of the longitudinal traveling step.

The method may further include a zigzag traveling step in which the end effector lowers the fry basket to a bottom of the fryer and then moves the fry basket to a zigzag path.

### BRIEF DESCRIPTION OF THE DRAWINGS

The patent or application file contains at least one color drawing. Copies of this patent or patent application publication with color drawing will be provided by the USPTO upon request and payment of the necessary fee.

FIG. 1 is a view illustrating an AI device constituting a robot system according to an embodiment.

FIG. 2 is a view illustrating an AI server of a robot system according to an embodiment.

FIG. 3 is a view illustrating an AI system to which a robot system is applied according to an embodiment.

FIG. 4 is a view showing a robot system according to an embodiment.

FIG. 5 is a side view showing an example of first-direction tilting of a fry basket by an end effector according to an embodiment.

FIG. 6 is a front view showing an example of second-direction tilting of a fry basket by an end effector according to an embodiment.

FIG. 7 is a front view of a fry basket is inverted by 180° in a second direction by an end effect according to an embodiment.

FIG. 8 is a view showing extraction of a color histogram according to an embodiment.

FIG. 9 is a view showing extraction of a gray histogram according to an embodiment.

FIG. 10 is a flowchart illustrating a method of controlling a robot system according to an embodiment.

FIG. 11 is a flowchart illustrating control start determination of a residue removal mode according to an embodiment.

FIG. 12 is a flowchart illustrating control end determination of a residue removal mode according to an embodiment.

FIG. 13 is a plan view when a robot arm moves in a transverse traveling mode according to an embodiment.

FIG. 14 is a flowchart illustrating an transverse traveling step according to an embodiment.

FIG. 15 is a plan view when a robot arm moves in a longitudinal traveling mode according to an embodiment.

FIG. 16 is a flowchart illustrating a longitudinal traveling step according to an embodiment.

FIG. 17 is a plan view when a robot arm travels in a shaking mode according to an embodiment.

FIG. 18 is a flowchart of a shaking step according to an embodiment.

FIG. 19 is a plan view when a robot arm moves in a zigzag traveling mode according to an embodiment.

FIG. 20 is a flowchart of a zigzag traveling step according to an embodiment.

### DETAILED DESCRIPTION OF THE PREFERRED EMBODIMENTS

Hereinafter, preferred embodiments of the present disclosure will be described in detail with reference to the drawings.

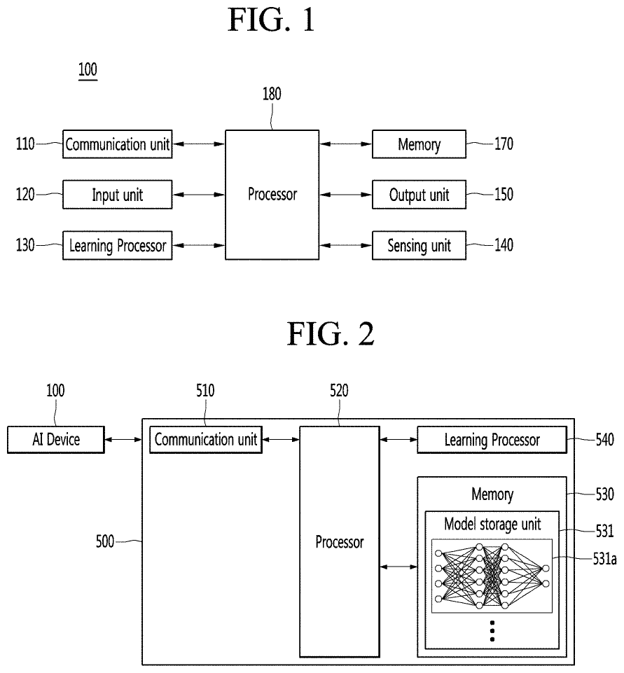

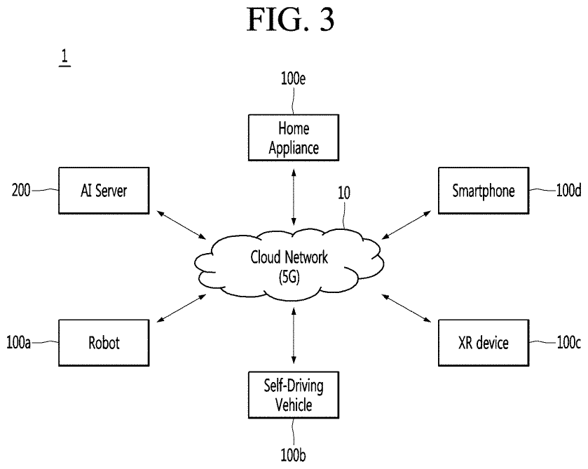

FIG. 1 is a view illustrating an AI device constituting a robot system according to an embodiment, FIG. 2 is a view illustrating an AI server of a robot system according to an embodiment and FIG. 3 is a view illustrating an AI system to which a robot system according to an embodiment is applied.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

FIG. 1 illustrates an AI device 100 including a robot according to an embodiment of the present disclosure.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 500 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 540 of the AI server 500.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 540 of the AI server 500, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 500. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 500 connected to a robot according to an embodiment of the present disclosure.

Referring to FIG. 2, the AI server 500 may refer to a device that learns an artificial neural network by using a machine learning algorithm or uses a learned artificial neural network. The AI server 500 may include a plurality of servers to perform distributed processing, or may be defined as a 5G network. At this time, the AI server 500 may be included as a partial configuration of the AI device 100, and may perform at least part of the AI processing together.

The AI server 500 may include a communication unit 510, a memory 530, a learning processor 540, a processor 520, and the like.

The communication unit 510 can transmit and receive data to and from an external device such as the AI device 100.

The memory 530 may include a model storage unit 531. The model storage unit 531 may store a learning or learned model (or an artificial neural network 531a) through the learning processor 540.

The learning processor 540 may learn the artificial neural network 531a by using the learning data. The learning model may be used in a state of being mounted on the AI server 500 of the artificial neural network, or may be used in a state of being mounted on an external device such as the AI device 100.

The learning model may be implemented in hardware, software, or a combination of hardware and software. If all or part of the learning models is implemented in software, one or more instructions that constitute the learning model may be stored in memory 530.

The processor 520 may infer the result value for new input data by using the learning model and may generate a response or a control command based on the inferred result value.

FIG. 3 illustrates an AI system 1 according to an embodiment of the present disclosure.

Referring to FIG. 3, in the AI system 1, at least one of an AI server 500, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 500 configuring the AI system 1 may be connected to each other through the cloud network 10. In particular, each of the devices 100a to 100e and 500 may communicate with each other through a base station, but may directly communicate with each other without using a base station.

The AI server 500 may include a server that performs AI processing and a server that performs operations on big data.

The AI server 500 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 500 may learn the artificial neural network according to the machine learning algorithm instead of the AI devices 100a to 100e, and may directly store the learning model or transmit the learning model to the AI devices 100a to 100e.

At this time, the AI server 500 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 500.

At this time, the robot 100a may perform the operation by generating the result by directly using the learning model, but the sensor information may be transmitted to the external device such as the AI server 500 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

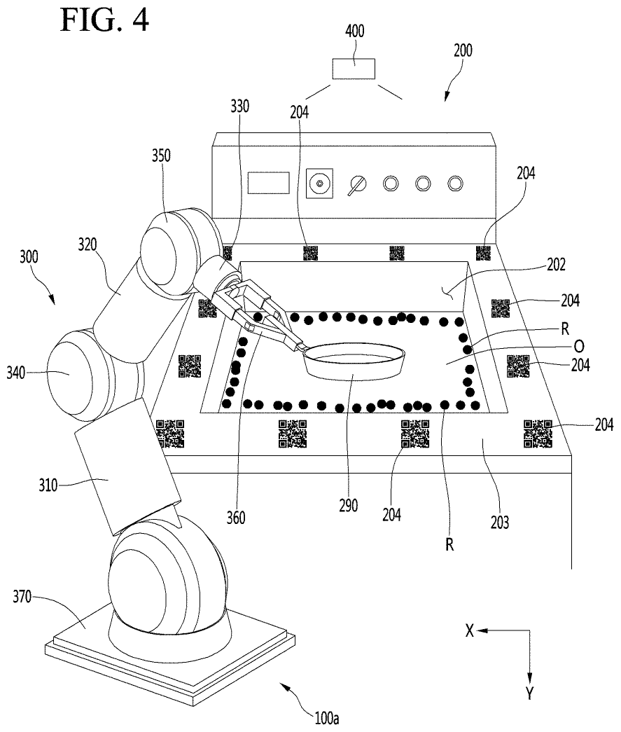

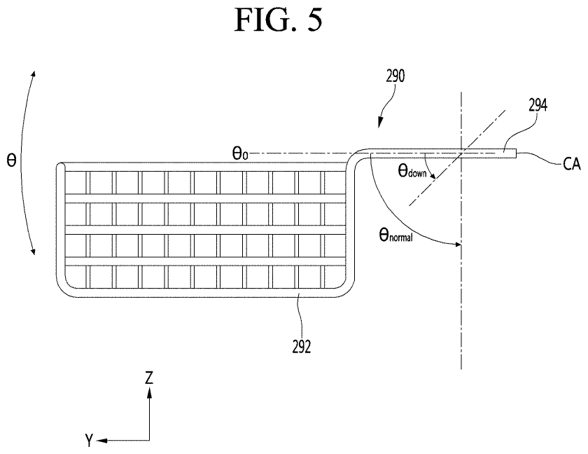

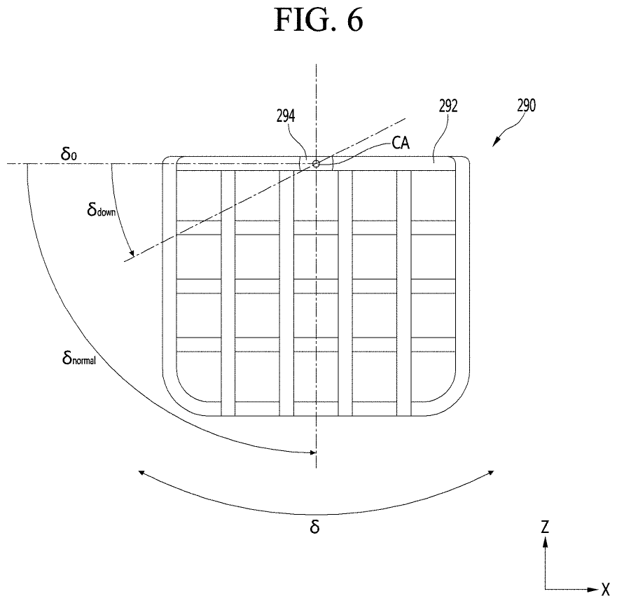

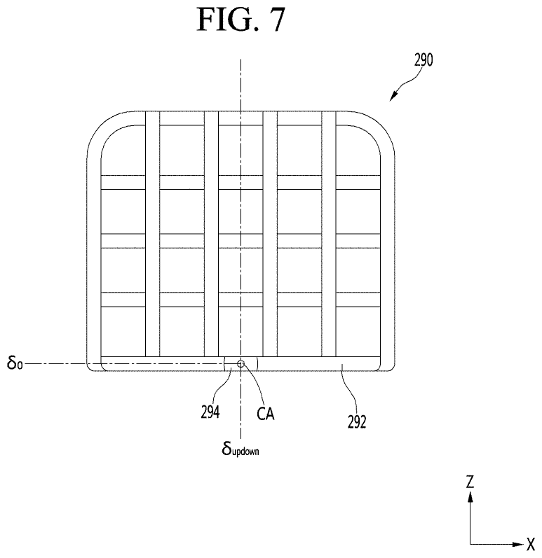

FIG. 4 is a view showing a robot system according to an embodiment, FIG. 5 is a side view showing an example of first-direction tilting of a fry basket by an end effector according to an embodiment, FIG. 6 is a front view showing an example of second-direction tilting of a fry basket by an end effector according to an embodiment, and FIG. 7 is a front view of a fry basket is inverted by 180° in a second direction by an end effect according to an embodiment.

The robot system may include a robot arm 300, as shown in FIG. 4. The robot arm 300 may sift out residue R from a fryer 200 with a fry basket 290 and then handle the residue R.

The fryer 200 may be an oil container in which various food such as chicken or donuts may be fired using oil O. The fryer 200 may have an opened upper surface. A space 202 in which oil O is contained may be formed in the fryer 200.

A plurality of QR codes 204 may be disposed in the fryer 200. The plurality of QR codes 204 may be spaced apart from each other. The plurality of QR codes 204 may be disposed on the upper portion of the fryer 200. The plurality of QR codes 204 may be disposed on the edge 203 of a body forming the space 202 of the fryer 200. The plurality of QR codes 204 may be sequentially disposed along the inner circumference of the fryer 200. The plurality of QR codes 204 may be given numbers for each QR code. The plurality of QR codes 204 may be used to determine the coordinates of a location in the space. The space 202 may be divided into a plurality of areas for each of the plurality of QR codes 204.

The fry basket 290 may include a three-dimensional mesh body 292 having an opened upper surface and a protrusion body 294 protruding from the mesh body 292.

The mesh body 292 may be composed of a three-dimensional grill or mesh having a height in a vertical direction. The mesh body 292 may be a container, one surface of which is opened.

Fried food or residue may be introduced into the mesh body 292 through one surface of the mesh body 292 and left in the mesh body 292 and oil in the fryer 200 may pass through the mesh body 292.

The mesh body 292 may have a rectangular parallelepiped shape, for example, and the mesh body 292 may have a rectangular parallelepiped shape and extend in the longitudinal direction of the protrusion body 294.

The protrusion body 294 may be a handle protruding from one side of the mesh body 292 or a bar having a hanger function.

The robot 100a may include at least one robot arm 300, and the robot arm 300 may be detachably connected to a cooking utensil such as the fry basket 290.

The robot arm 300 may perform various cooking operations in which the fry basket 290 may assist in cooking food in the space 202. The robot arm 300 may perform cooking operation of stirring the fry basket 290 in the space 202. The robot arm 300 may perform cooking operation of dipping the fry basket 290 into the oil O in the space 202 and then lifting the fry basket 290.

The robot arm 300 may include a plurality of arms 310, 320 and 330, arm connectors 240 and 350 connecting a pair of adjacent arms, and an end effector 360 connected to the arm.

The plurality of arms 310, 320 and 330 may be sequentially disposed with the arm connectors 340 and 350 interposed therebetween.

The end effector 360 may be installed at any one 330 of the plurality of arms 310, 320 and 330.

The robot arm 300 may include at least one motor or actuator for rotating the arms 310, 320 and 330, the arm connectors 340 and 350 and the end effector 360.

In the robot arm 300, if the end effector 360 may three-dimensionally move and rotate, the shapes or numbers of the plurality of arms 310, 320 and 330, the arm connectors 340 and 350, or the motors or actuators are not limited thereto and may be variously applied.

The robot 100a may further include a robot arm base 370 capable of connecting the robot arm 360 to another object or supporting the robot arm.

The robot arm base 370 may be mounted to be positioned on the fryer 200 or another object around the fryer 200.

The robot 100a may be a mobile robot which includes wheels and can move around the fryer 200.

The end effector 360 may be a robot hand or a gripper and may be mounted on the distal end of the robot arm 300 to perform various functions related to cooking, such that the robot arm 300 performs various operations related to cooking (hereinafter referred to as cooking operation).

The fry basket 290 may be connected to the end effector 360, and may be moved or rotated by the end effector 360.

Connection between the fry basket 290 and the end effector 360 may be defined as fixing the fry basket 290 to the end effector 360 such that the fry basket 290 moves or rotates integrally with the end effector 360, and may include the end effector 360 gripping the fry basket 290 or fitting the fry basket 290 into the end effector 360. For convenience, assume that the end effector 360 grips the fry basket 290.

The end effector 360 may three-dimensionally move, tilt and invert the fry basket 290 in a state of gripping the fry basket 290.

The robot arm 300 may three-dimensionally move and rotate the end effector 360, the end effector 360 may tilt the fry basket 290 in a first direction θ as shown in FIG. 5 or may tilt or invert the fry basket 290 in a second direction δ different from the first direction θ and lift up or lower the fry basket 290 in an upper-and-lower direction Z, as shown in FIGS. 6 and 7.

As shown in FIG. 5, the first direction θ may be a direction in which the fry basket 290 is lifted up or down. The fry basket 290 may be tilted in the first direction θ to be inclined in a lower inclination direction or an upper inclination direction.

The second direction δ may be a direction in which the fry basket 290 is tilted forward or backward with respect to the central axis CA of the fry basket 290 as shown in FIG. 6 or a direction in which the fry basket 290 is inverted by 180° with respect to the central axis CA of the fry basket 290 as shown in FIG. 7. That is, the second direction δ may be a direction in which the fry basket 290 is laid down forward or backward or inverted in a state in which the position of the central axis CA of the fry basket 290 is not changed.

The first direction θ may be defined as a direction in which the end effector 360 tilts the mesh body 292 upward or downward with respect to one side of the protrusion body 294 as shown in FIG. 5.

When the upper end of the fry basket 290 is horizontally located, the fry basket 290 may be defined as being located at a reference angle θ₀ of the first direction θ.

As shown in FIG. 5, the fry basket 290 may be tilted downward by a first angle θ_{down} with respect to the reference angle θ₀ of the first direction θ or may be tilted downward by a second angle θₙₒᵣₘₐₗ of 90° with respect to the reference angle θ₀ of the first direction θ.

The second direction δ may be a direction in which the end effector 360 tilts the upper surface of the mesh body 292 to the front upper side or forward with respect to the central axis CA of the protrusion body 294 or tilts the upper surface of the mesh body 292 to the back upper side or backward as shown in FIG. 6 or may be in a direction in which the upper surface of the mesh body 292 faces downward as shown in FIG. 7.

The fry basket 290 may be defined as being located at the reference angle δ₀ of the second direction δ when the upper surface of the fry basket 290 faces upward, as shown in FIG. 6.

As shown in FIG. 6, the fry basket 290 may be tilted by the first angle δ_{down} such that the upper surface of the fry basket 290 is inclined in the inclination direction of the front upper side or the inclination direction of the back upper side with respect to the reference angle δ₀ of the second direction δ, and may be tilted by the second angle δ₀ such that the upper surface of the fry basket 290 is rotated by 90° with respect to the reference angle δ₀ of the second direction δ.

When the fry basket 290 is tilted by the first angle δ_{down} in the second direction δ, the upper surface the fry basket 290 may face the front upper side or the rear upper side, and, when the fry basket 290 is tilted by the second angle δₙₒᵣₘₐₗ in the second direction δ, the upper side of the fry basket 290 may face forward or backward.

As shown in FIG. 7, the fry basket 290 may be inverted such that the upper side of the fry basket 290 is rotated by the third angle δ_{updown} of 180° with respect to the reference angle δ₀ of the second direction δ.

When the fry basket 290 is rotated by the third angle δ_{updown} in the second direction δ, the upper side of the fry basket 290 may face downward.

The robot system may further include a vision camera 400.

The vision camera 400 may sense the image of the fryer 200. The vision camera 400 may be disposed above the fryer 200 to be spaced apart from the fryer 200.

An example of the vision camera 400 may be an RGB camera or an RGB-D camera. Information on the image captured by the vision camera 400 may be transmitted to a controller.

The robot system may be controlled by a controller. The controller may be a server 500 or may be composed of the processor 180 of the robot 100a.

Hereinafter, for convenience, the controller may be used interchangeably with the processor and will be denoted by reference numeral 180.

The controller 180 may transmit a control signal to the robot arm 300, and the robot arm 300 may operate according to the control signal received from the controller 180.

When a chicken or donuts are cooked using the fryer 200 and then the cooked chicken or donuts are removed from the oil O, residue separated from a batter may remain in the oil O in the fryer 200.

The controller 180 may selectively perform a residue removal mode according to the state of the oil O in the fryer 200.

The controller 180 may perform the residue removal mode according to the sensing value of the vision camera 400.

The residue removal mode may refer to a mode in which the residue R remaining in the oil O is sifted out from the oil O and then is handled.

The residue removal mode may be one of various cooking operations performed by the robot arm 300. When a start condition of the residue removal mode is satisfied while cooking operation using the fryer 200 is performed, the robot system may stop the cooking operation and start the residue removal mode.

When the internal state of the fryer 200, that is, the state of the oil O and the state of the residue R, satisfies the start condition of the residue removal mode, the controller 180 may operate the robot arm 300 in the residue removal mode.

The color of the oil O before frying starts by the robot arm 300 and the fryer 200 may be different from that of the oil O after frying ends.

The distribution pattern of the residue R in the oil O before frying starts by the robot arm 300 and the fryer 200 may be different from that of the residue R in the oil O after frying ends.

The vision camera 400 may transmit, to the controller 180, the images of the fryer 200 and the oil O before frying starts, and transmit, to the controller 180, the images of the fryer 200 and the oil O after frying ends.

The robot system and, more particularly, the controller 1800 may compare and analyze the images sensed by the vision camera 400, start the residue removal mode according to the result of analysis, and end the residue removal mode according to the result of analysis.

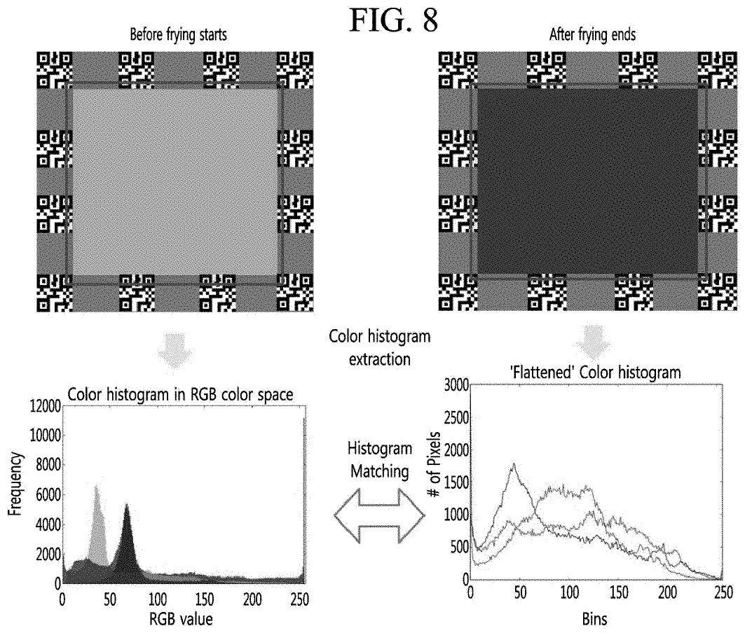

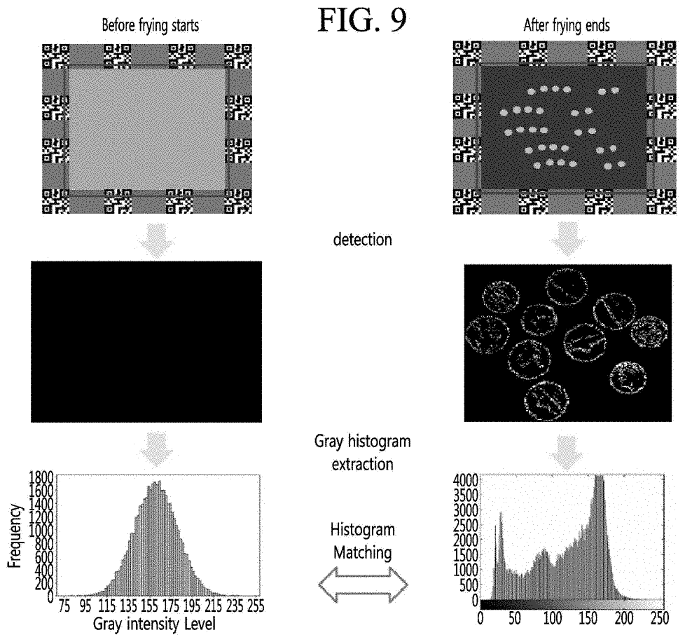

FIG. 8 is a view showing extraction of a color histogram according to an embodiment, and FIG. 9 is a view showing extraction of a gray histogram according to an embodiment.

The color of the oil O before frying starts may be light brown or a color close to light brown and little residue may be present in the oil O.

In contrast, the color of the oil O after frying ends may be dark brown or a color close to dark brown and a large amount of residue may be present in the oil O.

The controller 180 may analyze the image before frying starts, the image after frying ends, and the image after the residue removal mode is performed.

As shown in FIG. 8, the controller 180 may extract a color histogram before and after frying and perform color histogram matching.

As shown in FIG. 9, the controller 180 may detect the residue distribution pattern before and after frying to extract a gray histogram and perform gray histogram matching.

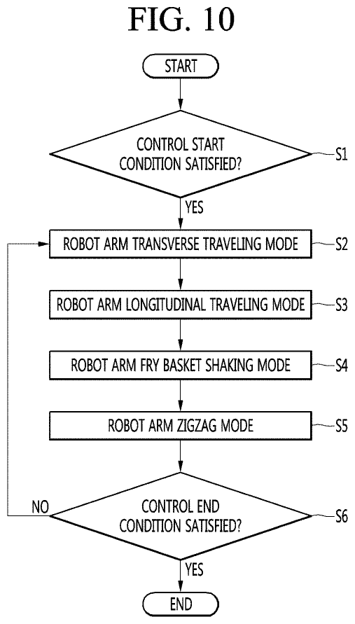

FIG. 10 is a flowchart illustrating a method of controlling a robot system according to an embodiment.

The method of controlling the robot system may include determining whether the control start condition of the residue removal mode is satisfied (S1).

The controller 180 may determine start of the residue removal mode by color histogram matching and gray histogram matching (S1).

Color histogram matching and gray histogram matching may be factors used to determine control start of the residue removal mode.

The method of controlling the robot system may start the residue removal mode, when the control start condition of the residue removal mode is satisfied (S1 and S2).

The residue removal mode may refer to a mode in which the fry basket 290 is moved, tilted or inverted by 180° in a trajectory and direction in which the fry basket 290 optimally sifts out the residue R in the oil O and, more particularly, the residue R in the surface of the oil.

During the residue removal mode, the controller 180 may perform control such that the robot arm 300 moves the fry basket 290 to a set residue removal path or tilts or rotates the fry basket 290.

The set residue removal path may be a set path in which the end effector 360 of the robot arm 300 moves the fry basket 290, and the set residue removal path may be defined as an entire path in which the end effector 360 of the robot arm 300 moves the fry basket 290 during the residue removal mode.

The set residue removal path may include a plurality of paths in which the end effector 360 of the robot arm 300 moves the fry basket 290 with elapse of time, and the set residue removal path may be a combination of a plurality of paths having different movement directions.

The set residue removal path may include a transverse traveling path, a longitudinal traveling path, a shaking path and a zigzag path.

Transverse may be defined as the left-and-right direction of the fryer 200, and longitude may be defined as the forward-and-backward direction of the fryer 200.

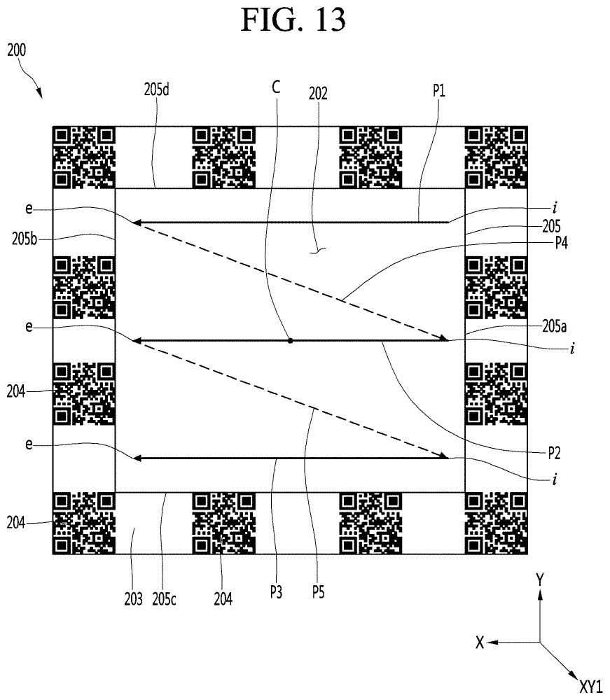

The transverse traveling path may be a path (see FIG. 13) in which the robot arm 300 lowers the fry basket 290 into the fryer 200 and moves the fry basket in a transverse direction X. The transverse traveling path may include a path in which the fry basket 290 moves in the fryer 200 in the left-and-right direction X.

The transverse traveling path may be a path in which the fry basket 290 moves in the transverse direction X at a height where the upper end of the fry basket 290 is closer to the surface of the oil O than the bottom of the fryer 200.

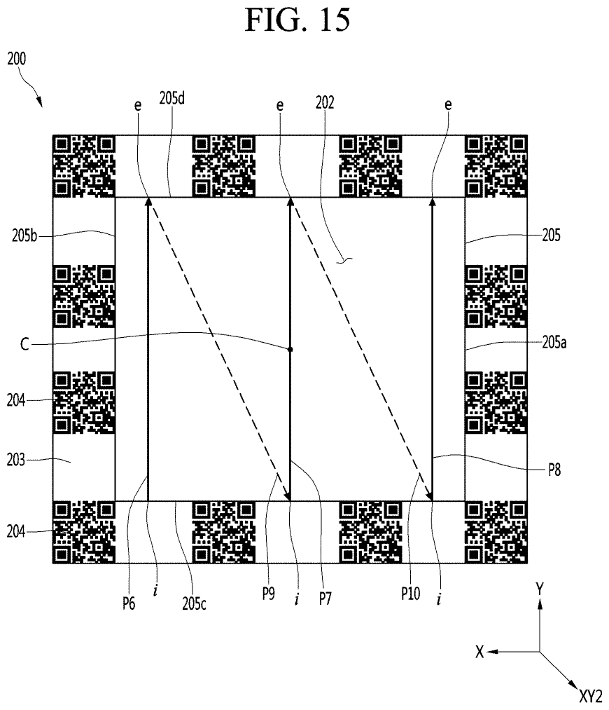

The longitudinal traveling path may be a path (see FIG. 15) in which the robot arm 300 lowers the fry basket 290 into the fryer 200 and moves the fry basket in the longitudinal direction. The longitudinal traveling path may include a path in which the fry basket 290 moves in the fryer 200 in the forward-and-backward direction Y.

The longitudinal traveling path may be a path in which the fry basket 290 moves in the longitudinal direction Y at the first height where the upper end of the fry basket 290 is closer to the surface of the oil O than the bottom of the fryer 200.

The transverse traveling path and the longitudinal traveling path may be set to a height where the residue on or near the surface of the oil in the fryer 200 is capable of being removed.

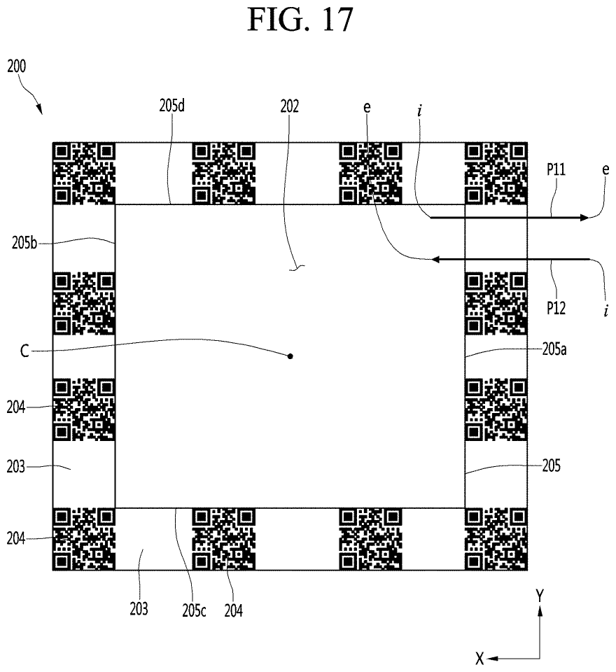

The shaking path may be a path (see FIG. 17) in which the robot arm 300 shakes the fry basket 290 after moving the fry basket 290 to the periphery of the fryer 200. The shaking path may include a path in which the fry basket 290 is lifted up to the upper side of the fryer 200 and then is moved to the periphery of the fryer 200. The shaking path may include a path in which the fry basket 290 is rotated at least once in the periphery of the fryer 200. The shaking path may include a path in which the fry basket 290 is moved from the outside of the fryer 200 to the inside of the fryer 200.

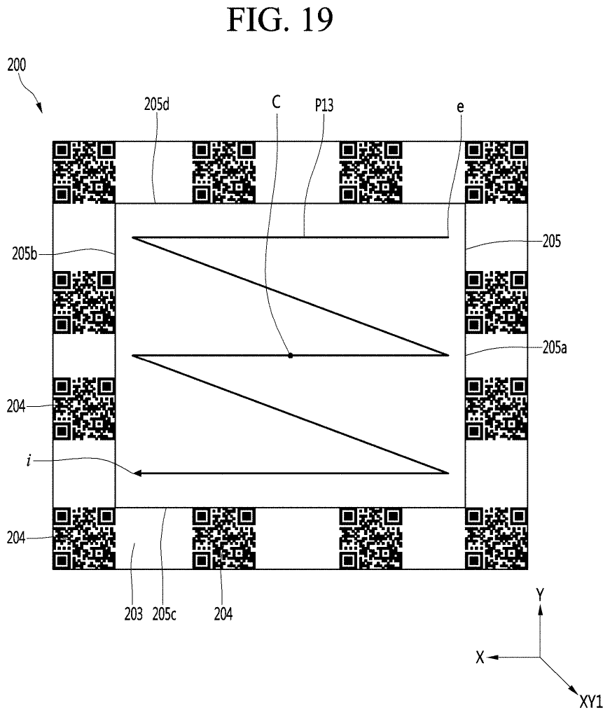

The zigzag path may be a path (see FIG. 19) in which the robot arm 300 lowers the fry basket 290 to the bottom of the fryer 200 and then moves the fry basket 290 in a zigzag line.

The zigzag path may be a path in which the fry basket 290 is moved in a zigzag line at a second height where the lower end of the fry basket 290 is in contact with the bottom of the fryer 200.

The zigzag path may be set to a height where the residue located near the bottom of the fryer 200 is capable of being sifted out, and may be set to the second height lower than the first height.

The residue removal mode may include a plurality of modes performed sequentially. The plurality of modes may include a transverse traveling mode in which the robot arm 300 moves the fry basket 290 along the transverse traveling path, a longitudinal traveling mode in which the robot arm 300 moves the fry basket 290 along the longitudinal traveling path, a shaking mode in which the robot arm 300 moves the fry basket 290 along the shaking path, and a zigzag traveling mode in which the robot arm 300 moves the fry basket 290 along the zigzag path.

The transverse traveling mode may be a mode in which the robot arm 300 performs operation of lowering the fry basket 290 into the fryer 200, moving the fry basket in the transverse direction and raising the fry basket at least once, and may be a mode in which the end effector 360 of the robot arm 300 moves the fry basket 290 along the transverse traveling path.

The longitudinal traveling mode may be a mode in which the robot arm 300 performs operation of lowering the fry basket into the fryer, moving the fry basket in the longitudinal direction, and raising the fry basket at least once, and may be mode in which the end effector 360 of the robot arm 300 moves the fry basket 290 along the longitudinal traveling path.

The shaking mode may be a mode in which the robot arm 300 shakes the fry basket 290 after moving the fry basket 290 to the periphery of the fryer, and may be a mode in which the end effector 360 of the robot arm 300 moves the fry basket 290 along the shaking path or rotates the fry basket.

The zigzag traveling mode may be a mode in which the robot arm 300 lowers the fry basket 290 to the bottom of the fryer 300 and then moves the fry basket 290 along the zigzag path, and may be a mode in which the end effector 360 of the robot arm 300 moves the fry basket 290 along the zigzag path.

The controller 180 may perform the plurality of modes in order of the transverse traveling mode, the longitudinal traveling mode, the shaking mode, and the zigzag traveling mode.

The method of controlling the robot system may control the robot system including the robot arm 300 in which the end effector 360 tilts the fry basket 290 in a first direction or a second direction different from the first direction or lifts up or lower the fry basket.

The method of controlling the robot system may include a transverse traveling step S2 in which the end effector 360 performs operation of lowering the fry basket 290 into the fryer 200, moving the fry basket in the transverse direction, and then raising the fray basket at least once; a longitudinal traveling step S3 in which the end effector 360 performs operation of lowering the fry basket 290 into the fryer 200, moving the fry basket in the longitudinal direction and then raising the fry basket at least once; a shaking step S4 in which the end effector 360 shakes the fry basket 290 after moving the fry basket 290 to the periphery of the fryer 200.

The method of controlling the robot system may further include a zigzag traveling step S5 in which the end effector 360 lowers the fry basket 290 to the bottom of the fryer 200 and then moves the fry basket 290 along the zigzag path.

The transverse traveling step S2 may be a step in which the robot arm 300 performs the transverse traveling mode.

The longitudinal traveling step S3 may be a step in which the robot arm 300 performs the longitudinal traveling mode.

During each of the transverse traveling step S2 and the longitudinal traveling step S3, the end effector 360 may sequentially move the fry basket 290 along a plurality of parallel traveling paths.

The shaking step S4 may be a step in which the robot arm 300 performs the shaking mode.

The zigzag traveling step S5 may be a step in which the robot arm 300 performs the zigzag traveling mode.

The controller 180 may determine whether a control end condition of the residue removal mode is satisfied after the zigzag traveling mode (S6).

In the method of controlling the robot system, upon determining that the control end condition of the residue removal mode is satisfied, the residue removal mode may be finished.

In the method of controlling the robot system, upon determining that the control end condition of the residue removal mode is not satisfied, the residue removal mode may be resumed to return to the transverse traveling step S2.

The controller 180 may determine the end of the residue removal mode by gray histogram matching (S6).

Gray histogram matching may be a factor used to determine control end of the residue removal mode.

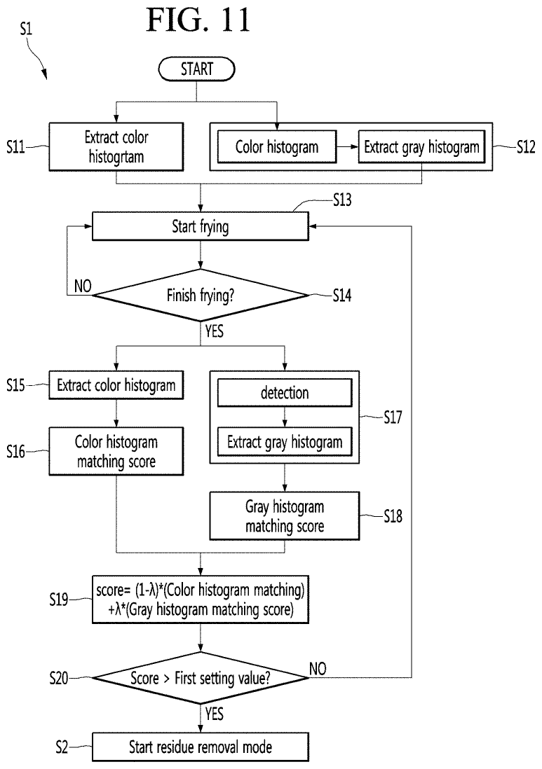

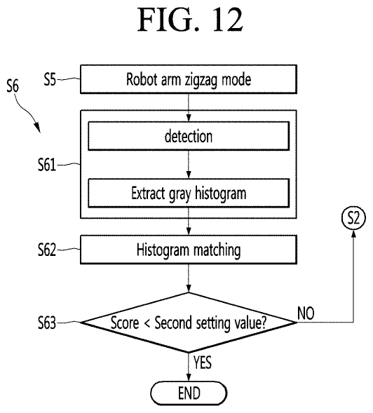

Hereinafter, control start determination of the residue removal mode will be described with reference to FIG. 11 and control end determination of the residue removal mode will be described with reference to FIG. 12.

FIG. 11 is a flowchart illustrating control start determination of a residue removal mode according to an embodiment.

The vision camera 400 may capture and transmit the image of the fryer 200 to the controller 180 before frying starts, may capture and transmit the image of the fryer 200 to the controller 180 after frying ends, and may capture and transmit the image of the fryer 200 to the controller 180 after the residue removal mode and, more particularly, the zigzag traveling mode.

The controller 180 may extract a color histogram from the image sensed by the vision camera 400 before frying starts (S11). In addition, the controller 180 may extract a gray histogram through image detection (S12).

As described above, in a state of extracting the color histogram and the gray histogram, the fryer 200 may heat the space 202 to fry a chicken or donuts in the space 202 (S13).

When cooking using the fryer 200 is completed, the vision camera 400 may transmit the image of the fryer 200 after completing frying to the controller 180 (S14).

The controller 180 may extract the color histogram from the image of the fryer 200 after completing frying and match the color histogram before frying starts with the color histogram after completing frying to calculate a color histogram matching score (S15 and S16).

Meanwhile, the controller 180 may extract the gray histogram by detecting a residue distribution pattern from the image of the fryer 200 after completing frying, and match the gray histogram before frying starts with the gray histogram after completing frying to calculate a color histogram matching score (S17 and S18).

The controller 180 may input the color histogram matching score and the gray histogram matching score to an equation or table to calculate a score (S19).

The controller 180 may compare the calculated score with a first setting value and start the residue removal mode when the calculated score exceeds the first setting value (S20).

When the calculated score is equal to or less than the first setting value, the controller 180 may not start the residue removal mode and perform a process in which the fryer 200 heats the space 202 to fry the chicken or donuts in the space 202.

When the color of the oil O or the residue distribution pattern is good, the residue removal mode may not start and further frying may be performed using the oil O. In this case, the residue removal mode may not be performed unnecessarily too frequently.

When the color of the oil O or the residue distribution pattern is not good, the controller 180 may start the residue removal mode.

FIG. 12 is a flowchart illustrating control end determination of a residue removal mode according to an embodiment.

The controller 180 may detect a residue pattern from the image sensed by the vision camera 400 and extract the gray histogram (S61), after performing the zigzag mode S5 of the robot arm.

The controller 180 may match the gray histogram extracted before frying starts with the gray histogram extracted after performing the zigzag mode S5 to calculate a gray histogram score according to gray histogram matching (S62).

The controller 180 may compare the calculated gray histogram score with a second setting value and end the residue removal when the calculated gray histogram score is less than the second setting value (S63).

When the color of the oil O or the residue distribution pattern is good by the residue removal mode, the residue removal mode may not be repeated and the residue removal mode may end such that further frying is performed using the oil O.

When the calculated gray histogram score is equal to or greater than the setting value, since the residue is not sufficiently removed by the residue removal mode, the controller 180 may resume the residue removal mode. To this end, it is possible to return to the transverse traveling mode S2.

When the color of the oil O or the residue distribution pattern is not good, the controller 180 may repeat the residue removal mode.

Hereinafter, detailed operation when the fry basket 290 is moved, tilted or inverted by 180° by the robot arm according to an embodiment will be described with reference to FIGS. 13 to 20.

The fry basket 290 may be moved by the robot arm 300 at a variable velocity V and may be moved at various velocities.

The various velocities of the fry basket 290 may include a lowering velocity Vdown when the fry basket 290 is lowered, a raising velocity Vup when the fry basket 290 is raised, a transverse velocity Vleft when the fry basket 290 moves along the traveling path in the transverse traveling mode, a longitudinal velocity Vforward when the fry basket 290 moves along the traveling path in the longitudinal traveling mode, a zigzag velocity Vzig when the fry basket 290 moves along a zigzag traveling path in the zigzag traveling mode, and a movement velocity Vmove when the fry basket 290 moves to an adjacent traveling path during the transverse traveling mode or the longitudinal traveling mode, moves to the outside of the fryer 200 or moves to an upper side of the fryer 200 during the shaking mode. The fry basket 290 may temporarily have a stop velocity Vo. In this case, the velocity of the fry basket 290 may be 0.

These velocities may have a relation of the lowering velocity Vdown=the raising velocity Vup<longitudinal velocity Vforward=transverse velocity Vleft=zigzag velocity Vzig<movement velocity Vmove.

Meanwhile, the fry basket 290 may be tilted by the robot arm 300 at a variable tilting angle and may be tilted by various tilting angles.

The various tilting angles may include the first angle θ_{down} of the first direction θ, and the second angle θₙₒᵣₘₐₗ of the first direction θ, and the first angle θ_{down} of the first direction θ may be less than the second angle θₙₒᵣₘₐₗ of the first direction θ.

The various tilting angle may include the first angle δ_{down} of the second direction δ and the second angle δₙₒᵣₘₐₗ of the second direction δ, and the first angle δ_{down} of the second direction δ may be less than the second angle δₙₒᵣₘₐₗ of the second direction δ. In addition, the first angle δ_{down} of the second direction δ may be less than the third angle δ_{updown} of the second direction δ.

The inner wall 205 of the fryer 200 shown in FIGS. 13, 15, 17 and 19 may include a right wall 205a, a left wall 205b, a rear wall 205c and a front wall 205d, and the space 202 in which the oil O is contained may be defined as being formed inside the inner wall 205.

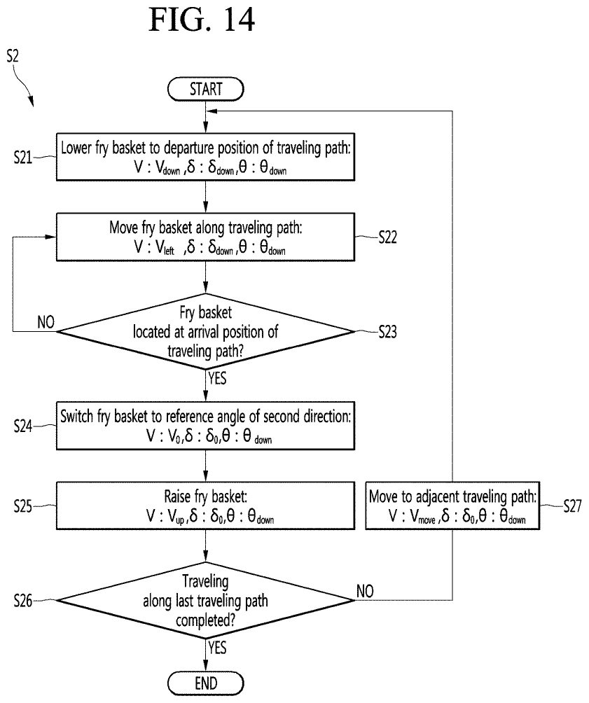

FIG. 13 is a plan view when a robot arm moves in a transverse traveling mode according to an embodiment, and FIG. 14 is a flowchart illustrating an transverse traveling step according to an embodiment.

During the transverse traveling step of performing the transverse traveling mode, the end effector 360 of the robot arm 300 may sequentially move the fry basket 290 along the plurality of parallel traveling paths P1, P2 and P3.

Each of the plurality of traveling paths P1, P2 and P3 of the transverse traveling mode may include a departure position i and an arrival position e and each of the departure position i and the arrival position e may be closer to the inner wall 205 of the fryer 200 than the center C of the fryer.

Each of the plurality of traveling paths P1, P2 and P3 of the transverse traveling mode may extend in the transverse direction X.

The departure positions i of the plurality of traveling paths P1, P2 and P3 of the transverse traveling mode may be spaced apart from each other in the direction Y perpendicular to the transverse direction X of the plurality of traveling paths P1, P2 and P3.

The departure positions i of each of the plurality of traveling paths P1, P2 and P3 of the transverse traveling mode may be closer to any one of the right wall 205a and the left wall 205b of the inner wall 205 of the fryer 200. The arrival position e of each of the plurality of traveling paths P1, P2 and P3 of the transverse traveling mode may be closer to the other of the right wall 205a and the left wall 205b of the inner wall 205 of the fryer 200.

The departure positions i of each of the plurality of traveling paths P1, P2 and P3 of the transverse traveling mode may be set to be closer to the right wall 205a than the left wall 205b or may be set to closer to the left wall 205b than the right wall 205a.

The plurality of traveling paths P1, P2 and P3 of the transverse traveling mode may extend in the transverse direction X and may be spaced apart from each other in the longitudinal direction Y.

The order of the plurality of traveling paths P1, P2 and P3 of the transverse traveling mode, along which the fry basket 290 moves, may be set in advance and may be sequentially set in the longitudinal direction Y.

The plurality of traveling paths P1, P2 and P3 of the transverse traveling mode may include a first traveling path P1 along which the fry basket 290 first moves and a last traveling path P3 along which the fry basket 290 moves last.

The number of traveling paths P1, P2 and P3 of the transverse traveling mode may be at least three. In this case, the plurality of traveling paths P1, P2 and P3 of the transverse traveling mode may further include at least one intermediate traveling path P2 after the fry basket 290 moves along the first traveling path P1 and before the fry basket moves along the last traveling path P3. In this case, a fry basket 290 may first move along the first traveling path P1, move along the intermediate traveling path P2 after moving to the intermediate traveling path P2, and move along the last traveling path P3 after moving to the last traveling path P3.

During the transverse traveling mode, the fry basket 290 may be moved by the end effector 360 along the traveling paths P1, P2 and P3 in a state of being tilted by a set angle with respect to reference angles θ₀ and δ₀.

Here, the set angle may be set for each of the first direction θ and the second direction δ.

The set angle of the first direction θ may be the first angle θ_{down} set with respect to the reference angle θ₀ of the first direction θ. In addition, the set angle of the second direction δ may be the first angle δ_{down} set with respect to the reference angle δ₀ of the second direction δ.

During the transverse traveling mode, the end effector 360 may sequentially perform a lowering process S21, traveling processes S22, S23 and S24 and a raising process S25.

During the lowering process S21, the end effector 360 may lower the fry basket 290 from an upper side of departure position i to the departure position i.

The robot arm 300 may lower the fry basket 290 at the lowering velocity Vdown, tilt the fry basket 290 by the first angle θ_{down} of the first direction θ, and tilt the fry basket 290 by the first angle δ_{down} of the second direction δ (S21).

The fry basket 290 may be inclined downward in the first direction θ, may be inclined laterally in the second direction δ, or may be lowered such that the lower portion thereof is located below the surface of the oil O.

The traveling processes S22, S23 and S24 may start when lowering of the fry basket 290 to the departure position i has been completed.

During the traveling processes S22, S23 and S24, the end effector 360 may move the fry basket 290 along the traveling path, and the fry basket 290 moved by the end effector 360 may move from the departure position i to the arrival position e of the traveling path in the transverse direction X (S22).

During the traveling processes S22, S23 and S24, the robot arm 300 may move the fry basket 290 at the transverse velocity Vleft, maintain the fry basket 290 at the first angle θ_{down} of the first direction θ, and maintain the fry basket 290 at the first angle δ_{down} of the second direction δ (S22).

During the traveling processes S22, S23 and S24, the fry basket 290 may be moved while sifting out the residue R located on the traveling path, and the residue R may be gradually accumulated in the fry basket 290.

During the traveling processes S22, S23 and S24, the fry basket 290 may reach the arrival position e of the traveling path, and the robot arm 300 may stop movement of the fry basket 290 (V; Vo) and switch the fry basket 290 to the reference angle δ₀ of the second direction δ, when the fry basket 290 reaches the arrival position e of the traveling path (S23 and S24). The robot arm 300 may maintain the first angle θ_{down} of the first direction θ of the fry basket 290 when the reference angle δ₀ of the second direction δ of the fry basket 290 is switched (S23 and S24).

In contrast, during the traveling process S22, when the fry basket 290 does not reach the arrival position e of the traveling path after departing from the departure position i of the traveling path, the traveling process S22 may be continuously performed (S23 and S22).

The traveling processes S22, S23 and S24 may end when switching of the fry basket 290 to the reference angle δ₀ of the second direction δ has been completed after the fry basket 290 has reached the arrival position e of the traveling path (S23 and S24).

The raising process S25 may be performed after the traveling processes S22, S23 and S24.

During the raising process S25, the end effector 360 may raise the fry basket 290 from the arrival position e of the traveling path.

During the raising process S25, the robot arm 300 may raise the fry basket 290 at the raising velocity Vup, and maintain the fry basket 290 at the first angle θ_{down} of the first direction θ and the reference angle δ₀ of the second direction δ.

During the raising process S25, the robot arm 300 may raise the fry basket 290 to the upper side of the surface of the oil O. When raising of the fry basket 290 to the upper side of the surface of the oil O has been completed, the raising process S25 may end.

During the transverse traveling step of performing the transverse traveling mode, the end effector 360 may move the fry basket 290 along the first traveling path P1, at least one intermediate traveling path P2 and the last traveling path P3 in this order.

After the raising process S25, the controller 180 may finish the transverse traveling mode or perform the movement processes S26 and S27, depending on whether traveling of the fry basket 290 along the last traveling path P3 has been completed.

If the position of the fry basket 290 before the raising process S25 is performed is the last traveling path P3, the controller 180 may finish the transverse traveling step S2 after the raising process S25.

In contrast, if the position of the fry basket 290 before the raising process S25 is performed is not the last traveling path P3, the controller 180 may perform the movement processes S26 and S27 of moving the fry basket 290 to an adjacent traveling path.

During the movement processes S26 and S27, the end effector 360 may move the fry basket 290 in an oblique direction XY1 crossing the traveling paths P1, P2 and P3 of the transverse traveling step S2 and the traveling paths P6, P7 and P8 of the longitudinal traveling step S3.

The movement paths P4 and P5 of the movement processes S26 and S27 may be a path from the upper side of the arrival position e of any one of a pair of adjacent traveling paths P1, P2 and P3 to the upper side of the arrival position e of another of the pair of adjacent traveling paths P1, P2 and P3, and the fry basket 290 may be moved in the oblique direction XY1 on the surface of the oil O while moving along the movement paths P4 and P5.

The movement paths P4 and P5 may include the path P4 from the upper side of the arrival position e of the first traveling path P1 to the upper side of the departure position i of the intermediate traveling path P2. In addition, the movement paths P4 and P5 may include the path P5 from the upper side of the arrival position e of the intermediate traveling path P2 to the upper side of the departure position i of the last traveling path P3.

During the movement processes S26 and S27, the robot arm 300 may move the fry basket 290 at the movement velocity Vmove, the fry basket 290 may be maintained at the first angle θ_{down} of the first direction θ and the reference angle δ₀ of the second direction δ (S27).

When the fry basket 290 reaches the departure position i of the adjacent traveling path, the robot arm 300 may repeat the lowering process S21 and the subsequent processes thereof. That is the robot arm 300 may sequentially perform the lowering process S21, the traveling processes S22, S23 and S24 and the raising process S25.

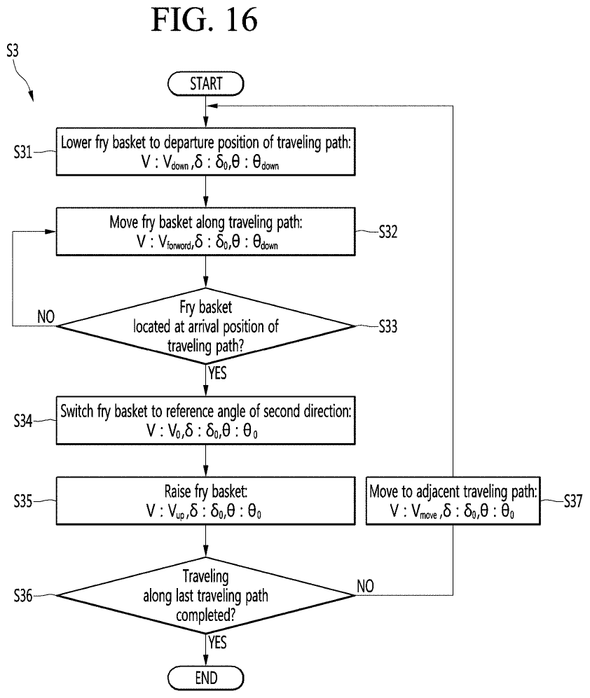

FIG. 15 is a plan view when a robot arm moves in a longitudinal traveling mode according to an embodiment, and FIG. 16 is a flowchart illustrating a longitudinal traveling step according to an embodiment.

The longitudinal traveling mode may be equal to the transverse traveling mode except that the movement direction of the fry basket 290 and the angle of the second direction δ of the fry basket 290 are different.

During the longitudinal traveling step of performing the longitudinal traveling mode, the end effector 360 of the robot arm 300 may sequentially move the fry basket 290 along a plurality of parallel traveling paths P6, P7 and P8.

Each of the plurality of traveling paths P6, P7 and P8 of the longitudinal traveling mode may include a departure position i and an arrival position e, and each of the departure position i and the arrival position e may be closer to the inner wall 205 than the center C of the fryer 200.

The plurality of traveling paths P6, P7 and P8 of the longitudinal traveling mode may extend in the longitudinal direction Y.

The departure positions i of the plurality of traveling paths P6, P7 and P8 of the longitudinal traveling mode may be spaced apart from each other in the direction X perpendicular to the direction Y of the plurality of traveling paths P6, P7 and P8.

The departure positions i of each of the plurality of traveling paths P6, P7 and P8 of the longitudinal traveling mode may be closer to any one of the rear wall 205c and the front wall 205d of the inner wall 205 of the fryer 200. The arrival position e of each of the plurality of traveling paths P6, P7 and P8 of the longitudinal traveling mode may be closer to the other of the rear wall 205c and the front wall 205d of the inner wall 205 of the fryer 200.

The departure position i of each of the plurality of traveling paths P6, P7 and P8 of the longitudinal traveling mode may be set to be closer to the rear wall 205c than the front wall 205d or may be set to be closer to the front wall 205d than the rear wall 205c.

The plurality of traveling paths P6, P7 and P8 of the longitudinal traveling mode may extend in the longitudinal direction Y and may be spaced apart from each other in the transverse direction X.

The order of the plurality of traveling paths P6, P7 and P8 of the longitudinal traveling mode, along which the fry basket 290 moves, may be set in advance and may be sequentially set in the transverse direction X.

The plurality of traveling paths P6, P7 and P8 of the longitudinal traveling mode may include a first traveling path P6 along which the fry basket 290 first moves and a last traveling path P8 along which the fry basket 290 moves last.

The number of traveling paths P6, P7 and P8 of the longitudinal traveling mode may be at least three. In this case, the plurality of traveling paths P6, P7 and P8 of the longitudinal traveling mode may include at least one intermediate traveling path P7 after the fry basket 290 moves along the first traveling path P6 and before the fry basket 290 moves along the last traveling path P8. In this case, a fry basket 290 may first move along the first traveling path P6, move along the intermediate traveling path P7 after moving to the intermediate traveling path P7, and move along the last traveling path P8 after moving to the last traveling path P8.

During the longitudinal traveling mode, the fry basket 290 may be moved by the end effector 360 along the traveling paths P6, P7 and P8 in a state of being tilted by a set angle with respect to reference angles θ₀.

Here, the set angle may be set for the first direction θ, and the fry basket 290 may be maintained at the reference angle δ₀ in the second direction δ in the longitudinal traveling mode.

The set angle of the first direction θ may be the first angle θ_{down} set with respect to the reference angle θ₀ of the first direction θ.

During the longitudinal traveling mode, the end effector 360 may sequentially perform a lowering process S31, traveling processes S32, S33 and S34 and a raising process S35.

During the lowering process S31, the end effector 360 may lower the fry basket 290 from an upper side of departure position i to the departure position i.

The robot arm 300 may lower the fry basket 290 at the lowering velocity Vdown, tilt the fry basket 290 to the first angle θ_{down} of the first direction θ, and maintain the fry basket 290 at the reference angle δ₀ of the second direction δ (S31).

The fry basket 290 may be inclined downward in the first direction θ, may be inclined upward in the second direction δ, and may be lowered such that the lower portion thereof is located below the surface of the oil O.

The traveling processes S32, S33 and S34 may start when lowering of the fry basket 290 to the departure position i has been completed

During the traveling processes S32, S33 and S34, the end effector 360 may move the fry basket 290 along the traveling path, and the fry basket 290 moved by the end effector 360 may move from the departure position i to the arrival position e of the traveling path in the longitudinal direction Y (S32).

During the traveling processes S32, S33 and S34, the robot arm 300 may move the fry basket 290 at the longitudinal velocity Vforward, maintain the fry basket 290 at the first angle θ_{down} of the first direction θ, and maintain the fry basket 290 at the reference angle δ₀ of the second direction δ (S32).

During the traveling processes S32, S33 and S34, the fry basket 290 may move while sifting out the residue R located on the traveling path, and the residue R may be gradually accumulated in the fry basket 290.

During the traveling processes S32, S33 and S34, the fry basket 290 may reach the arrival position e of the traveling path, and the robot arm 300 may stop movement of the fry basket 290 (V; Vo) and switch the fry basket 290 to the reference angle θ₀ of the first direction θ, when the fry basket 290 reaches the arrival position e of the traveling path (S33 and S34). The robot arm 300 may maintain the reference angle δ₀ of the second direction δ of the fry basket 290 when the reference angle θ₀ of the first direction θ the fry basket 290 is switched (S33 and S34).

In contrast, during the traveling process S32, when the fry basket 290 does not reach the arrival position e of the traveling path after departing from the departure position i of the traveling path, the traveling process S32 may be continuously performed (S33 and S32).

The traveling processes S32, S33 and S34 may end when switching of the fry basket 290 to the reference angle θ₀ of the first direction θ has been completed after the fry basket 290 has reached the arrival position e of the traveling path (S33 and S34).

The raising process S35 may be performed after the traveling processes S32, S33 and S34.

During the raising process S35, the end effector 360 may raise the fry basket 290 from the arrival position e of the traveling path.

During the raising process S35, the robot arm 300 may raise the fry basket 290 at the raising velocity Vup, and maintain the fry basket 290 at the reference angle θ₀ of the first direction θ and the reference angle δ₀ of the second direction δ.

During the raising process S35, the robot arm 300 may raise the fry basket 290 to the upper side of the surface of the oil O. When raising of the fry basket 290 to the upper side of the surface of the oil O has been completed, the raising process S35 may end.

During the longitudinal traveling step of performing the longitudinal traveling mode, the end effector 360 may move the fry basket 290 along the first traveling path P6, at least one intermediate traveling path P7 and the last traveling path P8 in this order.

After the raising process S35, the controller 180 may finish the longitudinal traveling mode or perform the movement processes S36 and S37, depending on whether traveling of the fry basket 290 along the last traveling path P8 has been completed.

If the position of the fry basket 290 before the raising process S35 is performed is the last traveling path P8, the controller 180 may finish the longitudinal traveling step S3 of performing the longitudinal traveling mode after the raising process.

In contrast, if the position of the fry basket 290 before the raising process S35 is performed is not the last traveling path P8, the controller 180 may perform the movement processes S36 and S37 of moving the fry basket 290 to an adjacent traveling path.

During the movement processes S36 and S37, the end effector 360 may move the fry basket 290 in an oblique direction XY2 crossing the traveling paths P1, P2 and P3 of the transverse traveling step S2 and the traveling paths P6, P7 and P8 of the longitudinal traveling step S3.

The movement paths P9 and P10 of the movement processes S36 and S37 may be a path from the upper side of the arrival position e of any one of a pair of adjacent traveling paths P6, P7 and P8 to the upper side of the arrival position e of another of the pair of adjacent traveling paths P6, P7 and P8, and the fry basket 290 may be moved in the oblique direction XY2 on the surface of the oil O while moving along the movement paths P9 and P10.

The movement paths P9 and P10 may include the path P9 from the upper side of the arrival position e of the first traveling path P6 to the upper side of the departure position i of the intermediate traveling path P7. In addition, the movement paths P9 and P10 may include the path P10 from the upper side of the arrival position e of the intermediate traveling path P7 to the upper side of the departure position i of the last traveling path P8.

During the movement processes S36 and S37, the robot arm 300 may move the fry basket 290 at the movement velocity Vmove, the fry basket 290 may be maintained at the reference angle θ₀ of the first direction θ and the reference angle δ₀ of the second direction (S37).

When the fry basket 290 reaches the departure position i of the adjacent traveling path, the robot arm 300 may repeat the lowering process S31 and the subsequent processes thereof. That is, the robot arm 300 may sequentially perform the lowering process S31, the traveling processes S32, S33 and S34 and the raising process S35.

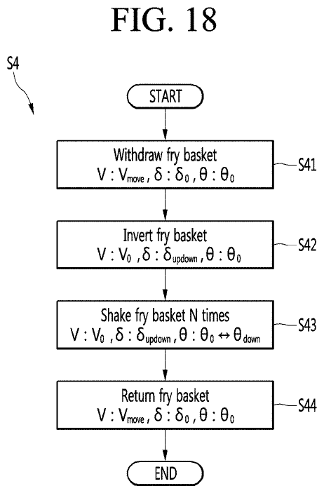

FIG. 17 is a plan view when a robot arm travels in a shaking mode according to an embodiment, and FIG. 18 is a flowchart of a shaking step according to an embodiment.

During the shaking mode, the robot arm 300 may invert the fry basket 290 by 180° in the second direction δ such that the fry basket 290 faces downward.

During the shaking mode, the robot arm 300 may invert the fry basket 290 by 180° in the second direction δ after moving the fryer 200 to an area outside the fryer 200.

During the shaking mode, the robot arm 300 may shake the fry basket 290 in the first direction θ a plurality of times in a state in which the fry basket 290 is inverted by 180° in the second direction δ.

During the shaking mode, the robot arm 300 may lower the fry basket 290 into the fryer 200, after the fry basket 290 is turned a plurality of times in the first direction θ.

The shaking step of performing the shaking mode may sequentially perform a withdrawal process S41 in which the robot arm 300 moves the fry basket 290 to an area outside the fryer 200, an inversion process S42 in which the robot arm 300 inverts the fry basket 290 in the second direction δ, and a shaking process S43 in which the robot arm 300 rotates the fry basket 290 forward and backward a plurality of times in the first direction. In addition, the shaking step of performing the shaking mode may perform a returning process S44 of lowering the fry basket 290 into the fryer 200 after the shaking process S43.

During the withdrawal process S41, the robot arm 300 may raise the fry basket 290 to the upper side of the fryer 200, and, when the fry basket 290 reaches the departure position i of a withdrawal path P11, the robot arm 300 may move the fry basket 290 along the withdrawal path P11.

The departure position i of the withdrawal path P11 may be the upper side of the fryer 200, and the arrival position e of the withdrawal path P11 may be the outside of the fryer 200 spaced apart from the upper side of the fryer 200 in a horizontal direction.

During the withdrawal process S41, the robot arm 300 may move the fry basket 290 at the movement velocity Vmove, and the fry basket 290 may be maintained at the reference angle θ₀ of the first direction θ and the reference angle δ₀ of the second direction.

During the withdrawal process S41, the fry basket 290 may carry the residue R sifted out from the oil O to the outside of the fryer 200, and the robot arm 300 may stop the fry basket 290 when the fry basket 290 reaches the arrival position e of the withdrawal path P11.

The inversion process S42 may be performed after the withdrawal process S41.

In the inversion process S42, the robot arm 300 may rotate the fry basket 290, which has reached the arrival position e, at the arrival position e by 180°, which is the third angle δ_{updown}, in the second direction δ, and the upper surface of the fry basket 290 may face downward at the arrival position e. At this time, some of the residue sifted by the fry basket 290 may be dropped from the fry basket 290.

When the fry basket 290 is inverted by 180°, the fry basket 290 may not be moved but may be stopped, and the fry basket 290 may be maintained at the reference angle δ in the first direction θ.

The inversion process S42 may end when rotation of the fry basket 290 by 180°, which is the third angle δ_{updown}, at the arrival position e in the second direction δ has been completed.

The shaking process S43 may be performed after the inversion process S42.

The shaking process S43 may perform operation (that is, shaking operation) of inclining the fry basket 290 inverted by 180° in the inversion process S42 by the first angle θ_{down} of the first direction θ and returning to the reference angle δ of the first direction θ a plurality of times N.

During the shaking process S43, the fry basket 290 may not be moved but may be stopped (V; Vo), the fry basket 290 may be rotated by 180°, which is the third angle δ_{updown}, in the second direction δ, and the robot arm 300 may rotate the fry basket 290 forward and backward at a set angular velocity. The robot arm 300 may rotate the fry basket 290 forward and backward a plurality of times.

As described above, in a state in which the fry basket 290 is inverted by 180° in the second direction δ, when the fry basket 290 is rotated forward and backward in the first direction θ a plurality of times, the residue adhered to the fry basket 290 may be separated from the fry basket 290 by inertia and may be dropped from the fry basket 290.

The shaking process S43 may end after the fry basket 290 is rotated forward and backward a plurality of times in the first direction θ.

The returning process S44 may be performed after the shaking process S43.

During the returning process S44, the robot arm 300 may switch the fry basket 290, which has completed the shaking process S42, to the reference angle θ₀ of the first direction θ and the reference angle δ₀ of the second direction, and move the fry basket 290 along a returning path P12.

The departure position i of the returning path P12 may be the outside of the fryer 200 spaced apart from the upper side of the fryer 200 in the horizontal direction, and the arrival position e of the returning path P12 may be the upper side of the fryer 200.

During the returning process S44, the robot arm 300 may move the fry basket 290 at the movement velocity Vmove, and the fry basket 290 may be moved to the upper side of the fryer 200 at the reference angle θ₀ of the first direction θ and the reference angle δ₀ of the second direction δ.

During the returning process S44, the robot arm 300 may move the fry basket 290 to the arrival position e of the returning path P12 and the returning process S44 may end.

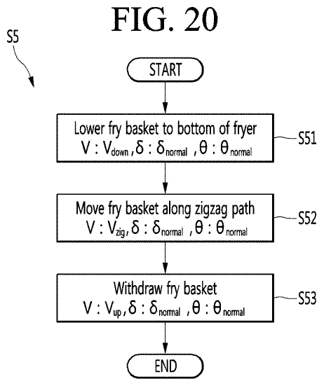

FIG. 19 is a plan view when a robot arm moves in a zigzag traveling mode according to an embodiment, and FIG. 20 is a flowchart of a zigzag traveling step according to an embodiment.

During the zigzag traveling mode, the robot arm 300 may lower the fry basket 290 to the zigzag path P13 and then move the fry basket 290 along the zigzag path P13.

The departure position i and the arrival position e of the zigzag path P13 may be the inside of the fryer 200 and, more particularly, the bottom of the fryer 200. The departure position i and the arrival position e of the zigzag path P13 may be located to be spaced apart from each other in the space 202 of the fryer 200 in an oblique direction.

During the zigzag traveling mode, the robot arm 300 may rotate the fry basket 290 by the second angle θₙₒᵣₘₐₗ in the first direction θ, and the robot arm 300 may move the fry basket 290 along the zigzag path P13 in a state of rotating the fry basket by the second angle δₙₒᵣₘₐₗ in the second direction δ.

The zigzag traveling step S5 of performing the zigzag traveling mode may include a lowering process S51 in which the robot arm 300 lowers the fry basket 290 to the bottom of the fryer 200, a movement process S52 in which the robot arm 300 moves the fry basket 290 along the zigzag path P13, and a raising step S53 in which the robot arm 300 raises the fry basket 290 to the upper side of the fryer 200.

During the lowering process S51, the robot arm 300 may place the fry basket 290 at the upper side of the departure position i of the zigzag path P13, and lower the fry basket 290 at the lowering velocity Vdown.

During the lowering process S51, the robot arm 300 may rotate the fry basket 290 by the second angle θₙₒᵣₘₐₗ in the first direction θ and rotate the fry basket 290 by the second angle δₙₒᵣₘₐₗ in the second direction δ.

The fry basket 290 may be lowered toward the bottom of the fryer 200 in a state in which the fry basket 290 extends in the upper-and-lower direction, and the lowering process S51 may end when the fry basket 290 reaches the departure position i located at the bottom of the fryer 200.

The movement process S52 may be performed after the lowering process S51.

During the movement process S52, the robot arm 300 may move the fry basket 290 along the zigzag path P13 at the zigzag velocity Vzig. During the movement process S52, the robot arm 300 may maintain the fry basket 290 at the second angle θₙₒᵣₘₐₗ of the first direction θ and the second angle δₙₒᵣₘₐₗ of the second direction δ.

During the movement process S52, the fry basket 290 may be moved to the upper surface of the bottom of the fryer 200 while sifting out the residue, and the residue close to the upper surface of the bottom of the fryer 200 may be sifted out by the fry basket 290 during the movement process S52.

The movement process S52 may end when the fry basket 290 reaches the arrival position e of the zigzag path P13.

The rising process S53 may be performed after the movement process S52.

During the rising process S53, the robot arm 300 may raise the fry basket 290 at the raising velocity Vup, and the fry basket 290 may be raised by the robot arm 300 to the upper side of the surface of the oil O.

During the rising process S53, the robot arm 300 may maintain the fry basket 290 at the second angle θₙₒᵣₘₐₗ of the first direction θ and the second angle δₙₒᵣₘₐₗ of the second direction δ, and the residue sifted out by the fry basket 290 may be moved to the upper side of the surface of the oil O along with the fry basket 290.

According to the embodiment, the fry basket may be tilted in both the first direction and the second direction different from each other and moved along the set residue removal path, such that the fry basket can reliably sift out the residue in the fryer.

In addition, since the residue removal mode may start by the image of the fryer, it is possible to minimize an unnecessary residue removal mode and to maximize a substantial cooking time by the robot.

In addition, the fry basket can reliably travel along the set residue removal path by the plurality of QR codes.

In addition, since the fry basket travels in the transverse direction and the longitudinal direction and then moves to the periphery of the fryer to remove the residue, it is possible to maximally sift out all residues in the fryer and to minimize the amount of remaining residue.

In addition, since the fry basket is lowered to the bottom of the fryer and is moved along the zigzag path to separate the residue adhered to the bottom of the fryer from the bottom of the fryer, it is possible to minimize the residue adhered to the bottom of the fryer and to cleanly manage the fryer.

In addition, since the fry basket can move in the transverse direction and the longitudinal direction in a state of being inclined, it is possible to more rapidly sift out the residue floating on the surface of the oil in the fryer.

The foregoing description is merely illustrative of the technical idea of the present disclosure and various changes and modifications may be made by those skilled in the art without departing from the essential characteristics of the present disclosure.

Therefore, the embodiments disclosed in the present disclosure are intended to illustrate rather than limit the technical idea of the present disclosure, and the scope of the technical idea of the present disclosure is not limited by these embodiments.

The scope of protection of the present disclosure should be construed according to the following claims, and all technical ideas falling within the equivalent scope to the scope of protection should be construed as falling within the scope of the present disclosure.

What is claimed is:

1. A robot system comprising:
a robot arm configured to tilt a fry basket in a first direction or in a second direction different from the first direction or lift up or lower the fry basket; and
a controller configured to perform a residue removal mode in which the robot arm rotates and moves the fry basket to a set residue removal path in which residue in a fryer is sifted out.

2. The robot system of claim 1,
wherein the first direction is a direction in which the fry basket is tilted upward or downward, and
wherein the second direction is a direction in which the fry basket is tilted forward or backward with respect to a center axis of the fry basket or is inverted by 180°.

3. The robot system of claim 1, further comprising a vision camera configured to sense an image of the fryer,
wherein the controller analyzes the image sensed by the vision camera, starts the residue removal mode and ends the residue removal mode.

4. The robot system of claim 1, wherein a plurality of QR codes is disposed on an upper portion of the fryer to be spaced apart from each other.

5. The robot system of claim 4, wherein the plurality of QR codes is sequentially disposed along an inner circumference of the fryer.

6. The robot system of claim 1,
wherein the residue removal mode includes a plurality of modes performed sequentially, and
wherein the plurality of modes includes:
a transverse traveling mode in which the robot arms performs operation of lowering the fry basket into the fryer, moving the fry basket in a transverse direction and then raising the fry basket at least once;
a longitudinal traveling mode in which the robot arm performs operation of lowering the fry basket into the fryer, moving the fry basket in a longitudinal direction and then raising the fry basket at least once; and
a shaking mode in which the robot arm moves the fry basket to the periphery of the fryer and then shakes the fry basket.

7. The robot system of claim 6, wherein the plurality of modes further includes a zigzag traveling mode in which the robot arm lowers the fry basket to a bottom of the fryer and then moves the fry basket to a zigzag path.

8. The robot system of claim 7, wherein the controller performs the plurality of modes in order of the transverse traveling mode, the longitudinal traveling mode, the shaking mode and the zigzag traveling mode.

9. The robot system of claim 6,
wherein the robot arm includes an end effector, and
wherein, in each of the transverse traveling mode and the longitudinal traveling mode, the end effector sequentially moves the fry basket along a plurality of parallel traveling paths.

10. The robot system of claim 9, wherein a departure position and an arrival position of each of the plurality of traveling paths is closer to an inner wall of the fryer than a center of the fryer.

11. The robot system of claim 9, wherein departure positions of the plurality of traveling paths are spaced apart from each other in a direction perpendicular to a longitudinal direction of each of the plurality of traveling paths.

12. The robot system of claim 9, wherein the end effector moves the fry basket on the traveling paths in a state in which the fry basket is tilted by a set angle with respect to a reference angle.

13. The robot system of claim 6, wherein, in the shaking mode, the robot arm inverts the fry basket by 180° in the second direction such that the fry basket faces downward.

14. The robot system of claim 6, wherein, in the shaking mode, the robot arm sequentially performs:
a withdrawal process in which the robot arm moves the fry basket to an area outside the fryer,
an inversion process in which the robot arm inverts the fry basket in the second direction, and
a shaking process in which the robot arm rotates the fry basket forward and backward a plurality of times in the first direction.

15. The robot system of claim 14, wherein, in the shaking mode, the robot arm performs a returning process of lowering the fry basket into the fryer after the shaking process.

16. A method of controlling a robot system including a robot arm configured to tilt a fry basket in a first direction or in a second direction different from the first direction or lift up or lower the fry basket, the method comprising:
moving the fry basket in a transverse direction, wherein an end effector of the robot arms performs operation of lowering the fry basket into a fryer, moving the fry basket in the transverse direction and then raising the fry basket;
moving the fry basket in a longitudinal direction, wherein the end effector performs operation of lowering the fry basket into the fryer, moving the fry basket in the longitudinal direction and then raising the fry basket; and
shaking the fry basket, after the end effector moves the fry basket to the periphery of the fryer.

17. The method of claim 16, wherein, during moving the fry basket in the transverse direction and moving the fry basket in the longitudinal direction, the end effector sequentially moves the fry basket along a plurality of parallel traveling paths.

18. The method of claim 17, wherein each of moving the fry basket in the transverse direction and moving the fry basket in the longitudinal direction includes:
a lowering process in which the end effector lowers the fry basket from an upper side of a departure position of a traveling path to the departure position,
a traveling process in which the end effector moves the fry basket along the traveling path,
a raising process in which the end effector raises the fry basket to an arrival position of the traveling path, and
a movement process in which the end effector moves the fry basket to an upper side of a departure position of another traveling path adjacent to the traveling path along which the fry baskets moves in the traveling process.

19. The method of claim 18, wherein, during the movement process, the end effector moves the fry basket in an oblique direction crossing each of the traveling path of the transverse traveling step and the traveling path of the longitudinal traveling step.

20. The method of claim 16, further comprising moving the fry basket along a zigzag path, wherein the end effector lowers the fry basket to a bottom of the fryer and then moves the fry basket to a zigzag path.
